(19) United States
(12) Patent Application Publication
(10) Pub. No.: US 2026/0166760 A1
(43) Pub. Date: Jun. 18, 2026

(54) THREE-DEGREES-OF-FREEDOM JOINT WITH FORCE FEEDBACK

(71) Applicant: POLLEN ROBOTICS, BORDEAUX (FR)

(72) Inventor: Jérémy LAVILLE, ST JEAN LE VIEUX (FR)

(73) Assignee: POLLEN ROBOTICS, BORDEAUX (FR)

(21) Appl. No.: 19/123,545

(22) PCT Filed: Oct. 25, 2023
(86) PCT No.: PCT/FR2023/051672

§ 371 Date: Apr. 23, 2025

(30) Foreign Application Priority Data
Oct. 28, 2022 (FR) FR2211298

(51) Int. Cl. B25J 17/02; B25J 9/00; B25J 13/08; B25J 19/00

(52) U.S. Cl. CPC B25J 17/0283; B25J 9/0048; B25J 13/088; B25J 19/0029

(57) ABSTRACT

Joint with three degrees of freedom for a robot, comprising a platform (2), three motors (3a, 3b, 3c) each connected to a ring by means of a pinion, each ring being disposed inside a hollow disc (6a, 6b, 6c) stacked on the base, so that each disc (6, 6a, 6b, 6c) is secured to a ring, each disc (6, 6a, 6b, 6c) is moreover itself secured to a disc head (7, 7a, 7b, 7c) extending in the same direction as the stack of the base and discs (6, 6a, 6b, 6c), for each disc head (7, 7a, 7b, 7c), an arm (8, 8a, 8b, 8c) is rotatably connected firstly to the disc head (7, 7a, 7b, 7c) and secondly to the platform (2), the joint with three degrees of freedom comprising a sphere(S) connected to the base (B) by a cylindrical bar (T), the sphere(S) being disposed at the centre of a cylindrical opening provided at the centre of the platform (2), the sphere(S), the cylindrical bar (T) and the base (B) cooperating in order to achieve a transfer of forces from those generated at the platform (2) and arms (8, 8a, 8b, 8c).

### TECHNICAL FIELD

The technical field of the invention is joints of robotic limbs, and more particularly such joints with three degrees of freedom.

### PRIOR ART

Robotic limbs generally use several articulations in order to confer the best possible mobility, like the limbs of a human being or of an animal.

A joint involves at least one degree of freedom, generally two or three degrees of freedom. Degrees of freedom means the possibility of performing a rotation on a predefined axis. Thus, with two degrees of freedom, a joint allows rotation on two distinct predefined axes, generally orthogonal. With three degrees of freedom, a joint allows rotation on three distinct predefined axes, also generally orthogonal.

Depending on the location thereof in the robotic limb, the joint requires a minimum number of degrees of freedom to enable the limb to operate. in particular, the joint placed in the wrist of a robotic arm requires at least two degrees of freedom. Nevertheless, using a joint with three degrees of freedom makes it possible to perform a wider range of movements similar to a human movement to the maximum possible extent.

From the prior art, the document “Marine Propulsor based on a Three-Degree-of-Freedom Actuated Spherical Joint”, Sudki B. et al., Third International Symposium on Marine Propulsors smp'13, Launceston, Tasmania, Australia, May 2013, is known.

This document describes a joint with three degrees of freedom for a marine propulsor making it possible to replicate the shoulder of marine animals, in particular of the penguin. The joint described comprises coaxial shafts connected to the motors and has a fixed centre of rotation, a working frequency of 2.5 Hz under load, an unlimited rotation on the main shaft and an arbitrary movement in a cone of +/−60°.

Nevertheless, the joint described in this document occupies a large amount of space in the frame accompanying it because in particular of the placing of the motors. The latter are disposed outside the joint strictly speaking and are configured to rotate three concentric shafts controlling the joint. It is clear from this structure that a major part of the interior volume of the joint is underused.

The document Gosselin C. et al. Kinematic analysis, optimization and programming of parallel robotic manipulator. McGill University (1985), presents the optimisation of parallel joints.

The document Asada H. et al., “Kinematic and static characterization of wrist joints and their optimal design,” Proceedings. 1985 IEEE International Conference on Robotics and Automation, 1985, pp. 244-250, doi: 10.1109/ROBOT.1985.1087324, is also known in relation to the modelling of wrist joints.

The document FR1912398 in the name of the applicant relating to a joint with three degrees of freedom for a robot and on the corresponding control method is also known.

The joint described in this document constituted a major advance in the field of robot joints. Nevertheless, it quickly appeared that it was nevertheless subject to various technical problems.

A first problem relates to the forces generated in the joint at the end of prolonged use, and leading to ageing of the assemblies resulting in the appearance of play in the assemblies. These plays in the assembly make the control imprecise and may lead to part of the joint breaking.

A second problem relates to the difficulty in routing the cables supplying and controlling the actuators or joints downstream of the joints with three degrees of freedom. This is because the major advantage of the joint with three degrees of freedom is the possibility of making an infinite rotation in a direction normal to the plane of the exit of the joint while benefiting from large rotation angles in the other planes, as well as not suffering gimbal lock. Nevertheless, as soon as an actuator is located downstream of the joint, the cables supplying and controlling this actuator limit the rotations actually accessible, either through their interaction with the arms, or through their interaction with the joint per se. It has become clear that such cables break or become tangled around the joint soon as large-amplitude rotations are performed. The advantage of large rotation angles and of an infinite rotation is thus neutralised. The same applies with regard to gimbal lock, which is replaced by locking related to the cables supplying and controlling the actuators downstream of the joint.

The aim of the present invention is to solve these technical problems.

### DESCRIPTION OF THE INVENTION

The object of the invention is a joint with three degrees of freedom for a robot, comprising a platform, three motors each connected to a ring by means of a pinion, each ring being disposed inside a hollow disc stacked on a base, so that each disc is secured to a ring, each disc is moreover itself secured to a disc head extending in the same direction as the stack of the base and discs.

For each disc head, an arm is rotatably connected firstly to the disc head and secondly to the platform, the platform being connected to the base and to the hollow discs only by the three arms, the joint with three degrees of freedom comprises a sphere connected to the base by a cylindrical bar, the sphere being disposed at the centre of a cylindrical opening provided at the centre of the platform, the sphere, the cylindrical bar and the base cooperating in order to achieve a transfer of forces from those generated at the platform and arms.

Each disc can comprise a bearing support designed so as to provide passages for inserting and positioning the pinions, the bearing support of each disc are stacked on one another and secured to the base by means of screws and threaded holes provided in the base, each bearing support receiving a bearing allowing rotation of the corresponding disc.

The bearing support and the corresponding bearing can be included in a disc lining, secured firstly to the ring relating to the disc and secondly to the corresponding disc head.

The disc lining can be provided with a rotation stop, the bearing support of each disc comprises a protrusion located on its bottom periphery, the outside diameter of the bottom periphery of the bearing support being less than the inside diameter of the corresponding lining, so that a groove is then formed when the lining and the bearing support are assembled, interrupted by the protrusion, the rotation stop of a disc and the protrusion of a disc immediately above cooperating in order to limit the rotation of the disc provided with the rotation stop.

A disc lining can comprise two stops, so as to be able to adjust, in cooperation with a protrusion, a positive rotation angle of said disc independently of the negative rotation angle of said disc.

Two protrusions can be provided on a bearing support, so as to be able to adjust, in cooperation with a stop, a positive rotation angle of said disc independently of the negative rotation angle of said disc.

A stop can be repositionable by means of a removable fixing on the corresponding lining and/or a protrusion is repositionable by means of a removable fixing on the corresponding bearing support.

One or more teeth of the ring of a disc may be omitted, so as to limit the rotation of the corresponding disc.

A motor can be provided with means for determining the angular position of its output shaft with respect to a reference position.

The means for determining angular position can comprise a plurality of magnetic sensors distributed circularly around the cylindrical bar, associated with a magnetic element disposed in each disc head so as to be able to be detected by the magnetic sensors.

The means for determining angular position can comprise sensors in line with each rotation shaft carrying a pinion.

The surface of the sphere can be provided with a coating minimising friction between the sphere and the platform, in particular of the polytetrafluoroethylene type.

The sphere, the cylindrical bar and the base are each provided with a through hole, each hole communicating with the others.

Another object of the invention is a robot limb, comprising at least two limb segments joined by a joint with three degrees of freedom as described above.

Another object of the invention is a robot limb comprising at least two limb segments joined by a joint with three degrees of freedom as described above as well as equipment disposed downstream of the joint with three degrees of freedom, the cable supplying and/or controlling said equipment being disposed through the hole in the sphere and the hollow cylindrical bar and through the hole in the base, to emerge between the motors.

### BRIEF DESCRIPTION OF THE DRAWINGS

Other aims, features and advantages of the invention will appear upon reading the following description, given solely as a non-limiting example and made with reference to the appended drawings wherein:

the FIG. 1 illustrates the main elements of a joint with three degrees of freedom according to the invention,

the FIG. 2 illustrates the main elements contributing to the transfer of force in a joint with three degrees of freedom according to the invention,

FIG. 3 illustrates the main elements contributing to the actuation of a joint a joint with three degrees of freedom according to the invention,

the FIG. 4 illustrates the main elements of a disc and of a corresponding arm,

the FIG. 5 illustrates the routing of the cables in a joint with three degrees of freedom according to the invention

the FIG. 6 illustrates the main elements of a disc and of a bearing support,

the FIG. 7 illustrates a bearing support,

the FIG. 8 illustrates the position of the joint with three degrees of freedom according to the invention after a command,

the FIG. 9 illustrates the rotation sensors disposed in a joint with three degrees of freedom according to the invention, and

the FIG. 10 illustrates a robotic arm comprising a joint with three degrees of freedom according to the invention.

### DETAILED DESCRIPTION

The joint according to the invention comprises a system with three parallel shafts controlling the joint. The joint 1 is illustrated by the figure [FIG. 1].

The joint 1 makes it possible to move a platform 2 on three axes of freedom with respect to a base B by controlling three motors 3a, 3b, 3c for rotation. The platform 2 is provided with a cylindrical opening at its centre. A sphere S is disposed at the centre of the platform 2, so that the centre of the sphere S is coincident with the centre of rotation of the platform 2. The surface of the sphere S is provided with a coating minimising friction between the sphere S and the platform 2, in particular of the PTFE type (the acronym for “polytetrafluoroethylene”).

The joint 1 comprises the base B in proximity to which the three motors 3a, 3b, 3c are disposed and on which discs 6a, 6b, 6c are stacked. Each disc 6a, 6b, 6c is moreover itself secured to a disc head 7a, 7b, 7c extending in the same direction as the stack of the base and discs 6a, 6b, 6c.

For each disc head 7, 7a, 7b, 7c, an arm 8, 8a, 8b, 8c in the form of an arc is rotatably connected firstly to the disc head 7, 7a, 7b, 7c and secondly to the platform 2. The figure [FIG. 2] illustrates such an arrangement. The connections between the disc heads 7, 7a, 7b, 7c and the corresponding arms 8, 8a, 8b, 8c are located in one and the same plane. In a similar manner, the connections between the arms 8, 8a, 8b, 8c and the platform 2 are included in one and the same plane. Advantageously, the arc shape represents a quarter of a circle.

The discs 6, 6a, 6b, 6c form casings and are provided with bearings facilitating the movement thereof, reducing friction and wear and maintaining the alignment of the discs 6, 6a, 6b, 6c with respect to the base and with each other.

The sphere S is connected to a cylindrical bar T itself connected to the base B. Such an arrangement enables the forces applied to the platform 2 to be transferred to the sphere S and, consequently, to the cylindrical bar T and the base B. The arms 8a, 8b, 8c are thus relieved of part of the forces perceived. More precisely, the advantage of such a configuration involving a sphere secured to the frame via the cylindrical bar lies in the fact that the majority of the forces applied to the platform 2 are absorbed by the assembly consisting of sphere, cylindrical bar and base, thus forming a sort of internal rigid skeleton.

The bending forces (perpendicular to the main axis) for example are completely absorbed by the assembly consisting of sphere, cylindrical bar and base, thus relieving the more fragile disc heads 7, 7a, 7b, 7c and arms 8, 8a, 8b, 8c. This has an important advantage when the joint 1 with three degrees of freedom is used to form a wrist. The forces resulting from the weight of the hand and of the object gripped are thus absorbed by the assembly consisting of a sphere, cylindrical bar and base.

in the same manner, the pressure forces (in the same direction as the axis of the cylindrical bar T) are also absorbed by the assembly consisting of sphere, cylindrical bar and base, and only very slightly stress the rigidity of the disc heads 7 and arms 8. This has an important advantage when the joint 1 with three degrees of freedom is used to form a neck. The forces resulting from the weight of the gripped head are thus absorbed by the assembly consisting of sphere, cylindrical bar and base.

The figure [FIG. 2] illustrates the sphere S, the cylindrical bar T and the base B. The discs 6a, 6b, 6c, the disc heads 7a, 7b, 7c, the arms 8a, 8b, 8c and the platform 2 are illustrated therein in transparency.

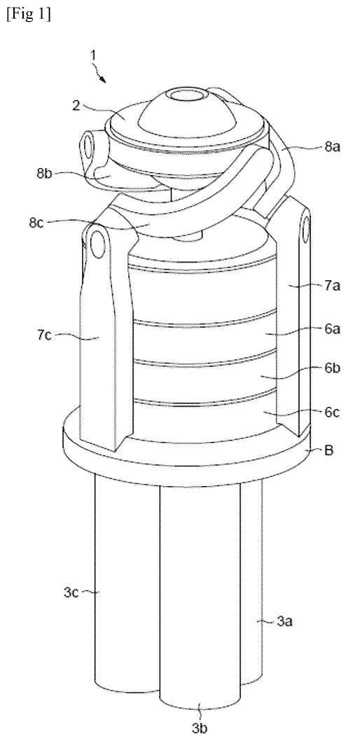

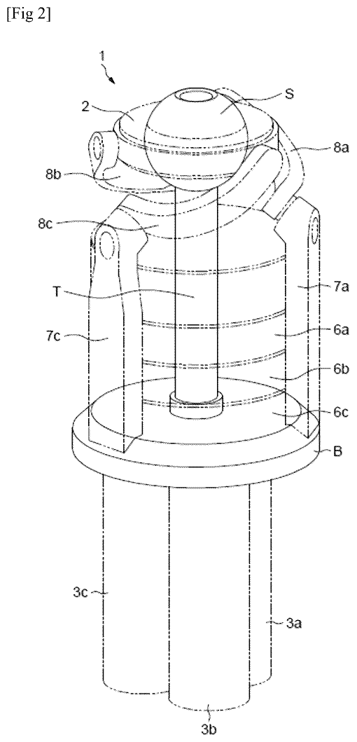

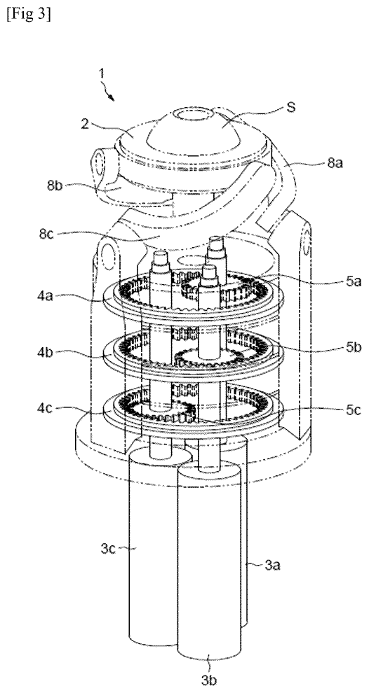

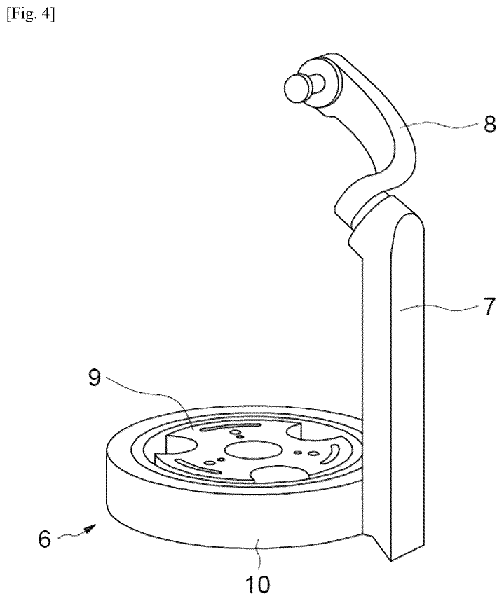

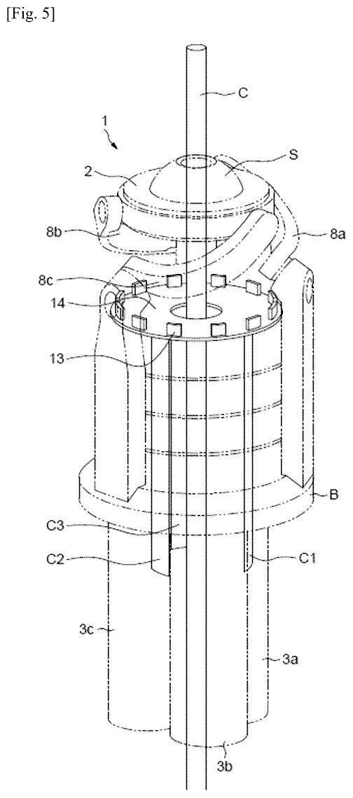

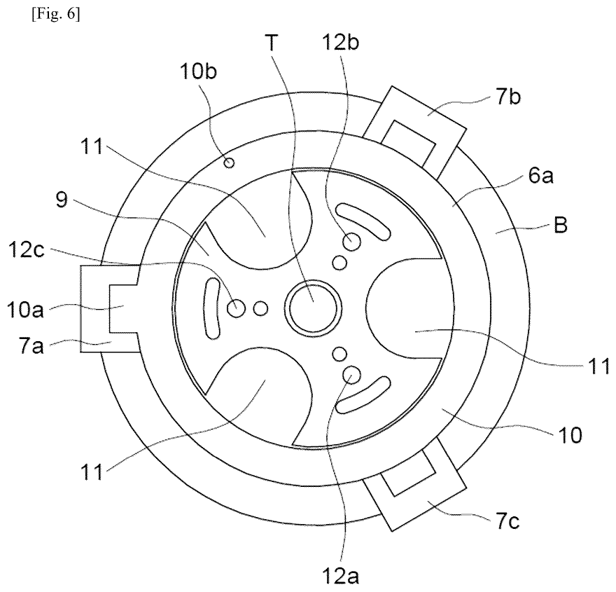

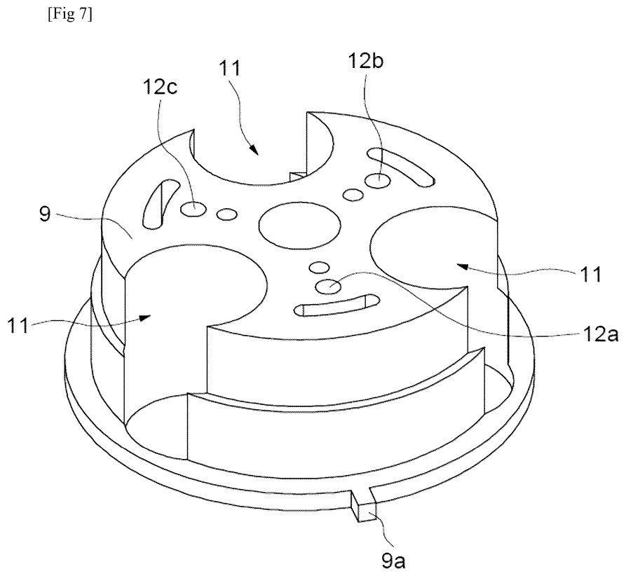

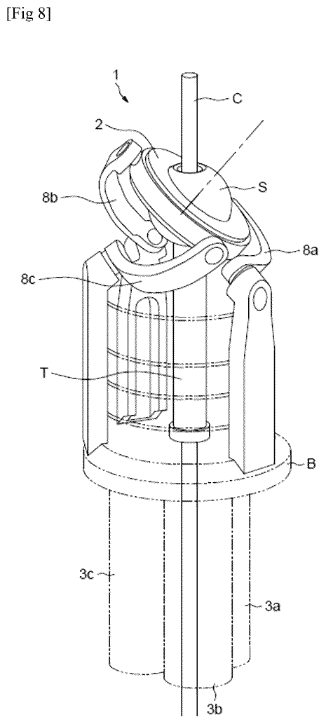

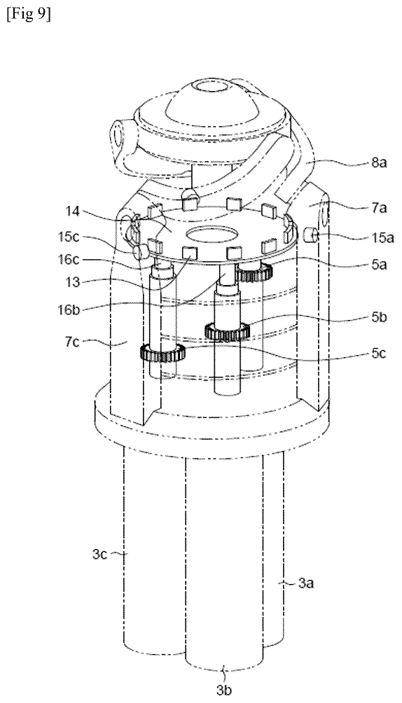

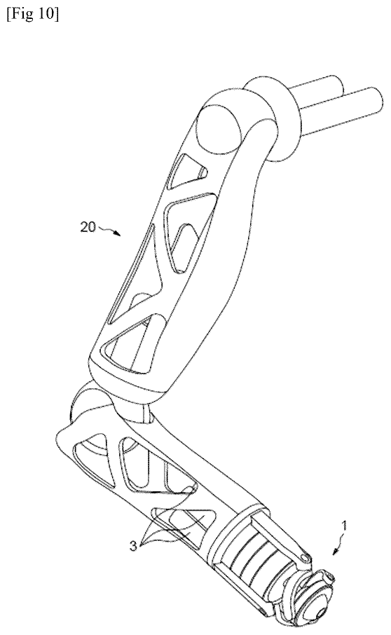

In the figure [FIG. 3] three motors 3a, 3b, 3c each connected to a ring 4a, 4b, 4c by means of a pinion 5a, 5b, 5c each carried by a shaft. The pinions 5a, 5b, 5c are disposed inside the rings 4a, 4b, 4c. Each pinion 5a, 5b, 5c is thus disposed at a different height from the base B so as to mechanically drive only the corresponding ring 4a, 4b, 4c.

Each ring 4a, 4b, 4c is disposed inside one of the hollow discs 6a, 6b, 6c, so that each disc 6a, 6b, 6c is secured to a ring 4a, 4b, 4c.

The motors 3a, 3b, 3c are controlled for rotation, which causes a rotation of each disc 6a, 6b, 6c over a circle referred to as the proximal circle. The rotation of each disc 6a, 6b, 6c causes the rotation of the arm 8a, 8b, 8c that is mechanically connected to it on another circle, referred to as the distal circle. Each arm 8a ,8b, 8c then applying a force to the platform 2 so as to change the position thereof.

Each pinion 5a, 5b, 5c and each corresponding spindle are disposed in a different sector of 120°. This offset angle of 120°is also found at the idle position of each disc head 7, 7a, 7b, 7c, each disc head 7, 7a, 7b, 7c being disposed at 120° from the other two.

The figure [FIG. 4] illustrates a disc 6 comprising a bearing support 9, and a lining 10 connected to a disc head 7 itself connected to an arm 8. The assembly formed by the disc 6, the disc head 7 and the arm 8 is associated with one of the three axes or degrees of freedom of the joint. The joint thus comprises three similar assemblies, each associated with a different degree of freedom. Using three similar assemblies also makes it possible to reduce production costs, both in digital machining and in plastic injection.

Each disc 6, 6a, 6b, 6c comprises a bearing support 9 designed so as to provide passages for inserting and positioning pinions 5a, 5b, 5c connected to the motors by shafts. Because of the small amount of forces perceived by this part, it can be produced both by plastic injection and by digital machining. The bearing supports 9 of each disc 6, 6a, 6b, 6c are stacked on one another and secured to the base B by means of screws. These screws are designed so as to cooperate with threaded holes provided in the base B. It will then be understood that each bearing support 9 is secured to the base B whereas the discs 6, 6a, 6b, 6c are rotated by the corresponding ring 4, 4a, 4b, 4c.

Each bearing support 9 is associated with a bearing ensuring rotation of the corresponding disc 6, 6a, 6b, 6c and maintaining the position thereof in the joint 1. The bearing support 9 and the corresponding bearing are included in a disc lining 10, secured to the ring 4a, 4b, 4c relating to the disc. The disc lining 10 is secured to a disc head 7 by means of a shoulder 10a and securing means.

In other words, a first disc 6a is connected to a first arm 8a by means of a disc head 7a, the first disc 6a being driven by a first motor 3a by means of a first ring 4a and a first pinion 5a. The similar arrangement is provided for the second disc 6b and the third disc 6c, for which an end of each arm is connected to the disc head at a different height of the lining 10. The other end of each arm 8a, 8b, 8c is then connected to the platform 2 whereas the platform 2 is included in a plane normal to the axis of the cylindrical bar.

In a particular embodiment illustrated by the figure [FIG. 5], the sphere S, the cylindrical bar T and the base B are each provided with a through hole, each hole communicating with the others. It will be understood that, in the case of the cylindrical bar T, the hole is provided in the form of an axial piercing. The cylindrical bar T is then in essence a hollow tube. The advantages relating to the assembly consisting of sphere, cylindrical bar and base described above are also valid here when the cylindrical bar is provided with an axial piercing.

In the case of equipment, in particular an actuator, disposed downstream of the joint, the cable C supplying and/or controlling this equipment can be disposed through the hole in the sphere S, in the hollow tube T and through the hole in the base B, to emerge between the motors 3a, 3b, 3c. The cable C travels in the hollow tube T, between the pinions 5a, 5b, 5c and inside the rings 4a, 4b, 4c, through the central hole in the bearing support 9 of each disc 6, 6a, 6b, 6c. It does not interact with the operation of the joint and is protected from the environment inside the joint. The cable C thus disposed can also not interact with the arms 8a, 8b, 8c, thus protecting the joint from damage.

In a particular implementation of this embodiment, the amplitude of rotation of the discs 6, 6a, 6b, 6c is limited so as to avoid damaging the cable C by twisting when the equipment to which it is connected rotates, equipment disposed downstream of the joint 1.

To implement this, stops and protrusions are disposed in the various discs in order to limit the rotation thereof.

More precisely, a disc lining 10 is provided with a rotation stop 10b intended to limit the rotation of the corresponding disc 6, 6a, 6b, 6c. The figure [FIG. 6] illustrates a disc 6a comprising a bearing support 9, a lining 10 and a rotation stop 10b and secured to a disc head 7a. The other disc heads 7b, 7c are shown but are not secured to the lining 10 of this disc 6a. The bearing support 9 comprises passages 11 for inserting the pinions 5a, 5b, 5c and holes 12a, 12, 12c in which the screws for holding to the base B are inserted. The hollow tube T extends at the centre of the bearing support.

In addition to the stops 10b, the bearing support 9 of each disc 6, 6a, 6b, 6c comprises a protrusion 9a located on the lower periphery thereof. The figure [FIG. 7] illustrates such a bearing support 9 provided with a protrusion 9a. The passages 11 and the holes 12a, 12b, 12c are found.

To enable the disc provided with a stop to rotate, a space is provided between the lining 10 and the bearing support 9. This is achieved by providing an outside diameter of the lower portion of the bearing support 9 smaller than the inside diameter of the corresponding lining 10. A groove is then formed when the lining 10 and the bearing support 9 are assembled, interrupted by the protrusion 9a.

A disc 6, 6a, 6b, 6c is thus free to turn until the stop 10b present on its lining 10 comes into contact with the protrusion 9a of the bearing support 9 of the disc immediately above. The last disc 6c in the stack has its rotation blocked by a similar protrusion disposed in a lining disposed immediately above. Depending on the respective placing of the stops and protrusions, it is possible to limit the rotation accessible to each disc. For a placing of a stop and protrusion, the disc can access a positive rotation angle and a negative rotation angle defined with respect to an idle position. The joint in its entirety is then limited to a positive angle and to a negative angle equal respectively to the sum of the positive and negative angles accessible to each disc. In such a configuration the sum of the positive angle and negative angle of a disc is always equal to 360°.

In a variant, a stop can be disposed on either side of the idle position, so as to be able to adjust the positive rotation angle independently of the negative rotation angle. The positive rotation angle can be equal to or different from the negative rotation angle. It will be understood that, in such a variant, a disc lining comprises two stops that each cooperate with a protrusion on the bearing support of the disc immediately above. In such a configuration the sum of the positive angle and negative angle of a disc is less than or equal to 360°.

The same effect will be obtained if a stop is disposed on a lining and two protrusions on the bearing support immediately above.

The stops can also be repositionable by means of a removable fixing on the corresponding lining. It may for example be a stop to be fitted in a hole, several holes being provided on the lining, regularly distributed or not. It may also be a stop to be screwed onto threaded holes.

Alternatively, the rotation of a disc can be limited by eliminating or omitting one or more teeth on the corresponding ring.

The figure [FIG. 8] illustrates the joint 1 with three degrees of freedom after implementation of a command. It should be noted that the platform is inclined with respect to its idle position illustrated by the figure [FIG. 1]. It should also be noted that the outlet orifice of the sphere S remains clear despite the inclination of the platform 2. Because of the angles that can be achieved by the platform 2 in planes normal to the plane of the platform 2, this outlet orifice is always clear so that it is not possible for the cable C to be sheared by the platform.

Each motor 3a, 3b, 3c is moreover provided with means for determining the angular position of its output shaft with respect to a reference position. Such determination means are illustrated by the figure [FIG. 9].

In a first embodiment, the means for determining angular position comprise a plurality of magnetic sensors 13 disposed on a plate 14, advantageously the interface printed circuit of the magnetic sensors 13. The plurality of magnetic sensors 13 are distributed uniformly on the periphery of the plate 14 so that the separation between two immediately succeeding magnetic sensors is constant over the entire periphery.

In each disc head 7a, 7b, 7c, a magnetic element 15a, 15b, 15c is installed, disposed so as to be able to be detected by the magnetic sensors 13. It will be understood that such an arrangement is based on the match between the intensity of the magnetic field emitted by each magnetic element 15a, 15b, 15c, the sensitivity of the magnetic sensors 13, considered alone or in combination, and the distance between each magnetic element and the plurality of magnetic sensors 13. In order to be able to associate the magnetic elements of each disc head with a given position, the joint 1 is initialised by demanding a small movement of each disc, one after the other. The position of the magnetic element detected by the magnetic sensor 13 is then associated with the disc set in motion. Once the three discs have been set in motion, the three magnetic elements (in the case illustrated here) are identified. The movement thereof can then be followed along with the commands transmitted to the joint.

In a second embodiment, the means for determining angular position comprise sensors 16a, 16b, 16c in line with each rotation axis carrying a pinion 5a, 5b, 5c. The sensors 16a, 16b, 16c make it possible to implement closed-loop control of the rotation of the motors 3a, 3b, 3c.

In a third embodiment, the means for determining position comprise a combination of magnetic sensors 13 and magnetic elements 15a, 15b, 15c according to the first embodiment and of rotation-speed sensors 16a, 16b, 16c according to the second embodiment. FIG. 5 illustrates such an embodiment, making it possible to detect the position of disc heads 7 and arms 8 at the start of the setting in motion of the joint 1 by virtue of the combination of magnetic sensors 13 and magnetic elements 15a, 15b, 15c and then following their movement with precision by means of the rotation-speed sensors 16a, 16b, 16c.

Referring once again to the figure [FIG. 5], it can be noted that the cable or cables C1, C2, C3 connecting the magnetic sensor 13 and/or the rotation-speed sensors 16a, 16b, 16c are disposed inside the joint as with the cable C supplying and controlling equipment downstream of the joint.

Referring once again to the figure [FIG. 6], it can be noted that apertures are formed in each bearing support for these cables C1, C2, C3, said apertures being formed in alignment with the passages 11, hollow tube T and stops 12a, 12b, 12c. Just like the cable C, the cables C1, C2, C3 are thus protected by the joint.

The figure [FIG. 10] illustrates a robotic arm 20 wherein the wrist joint is implemented by a joint 1 with three degrees of freedom according to the invention. It should be noted that the motors 3 are disposed inside the robotic arm 20 so that they are both protected and concealed. The cables C, C1, C2, C3 are also included inside the robotic arm 20 and are therefore also protected.

1. Joint with three degrees of freedom for a robot, comprising a platform (2), three motors (3a, 3b, 3c) each connected to a ring (4, 4a, 4b, 4c) by means of a pinion (5a, 5b, 5c), each ring (4, 4a, 4b, 4c) being disposed inside a hollow disc (6a, 6b, 6c) stacked on a base (B), so that each disc (6, 6a, 6b, 6c) is secured to a ring (4, 4a, 4b, 4c), each disc (6, 6a, 6b, 6c) is moreover itself secured to a disc head (7, 7a, 7b, 7c) extending in the same direction as the stack of the base (B) and discs (6, 6a, 6b, 6c), for each disc head (7, 7a, 7b, 7c), an arm (8, 8a, 8b, 8c) is rotatably connected firstly to the disc head (7, 7a, 7b, 7c) and secondly to the platform (2), the platform being connected to the base (B) and to the hollow discs only by the three arms (8, 8a, 8b, 8c), characterised by the fact that the joint with three degrees of freedom comprises a sphere(S) connected to the base (B) by a cylindrical bar (T), the sphere(S) being disposed at the centre of a cylindrical opening provided at the centre of the platform (2), the sphere(S), the cylindrical bar (T) and the base (B) cooperating in order to achieve a transfer of forces from those generated at the platform (2) and arms (8, 8a, 8b, 8c).

2. Joint with three degrees of freedom according to claim 1, wherein each disc (6, 6a, 6b, 6c) comprises a bearing support (9) designed so as to provide passages for inserting and positioning the pinions (5a, 5b, 5c), the bearing support (9) of each disc (6, 6a, 6b, 6c) are stacked on one another and secured to the base (B) by means of screws and threaded holes provided in the base (B), each bearing support (9) receiving a bearing allowing rotation of the corresponding disc (6, 6a, 6b, 6c).

3. Joint with three degrees of freedom according to claim 2, wherein the bearing support (9) and the corresponding bearing are included in a disc lining (10), secured firstly to the ring (4a, 4b, 4c) relating to the disc and secondly to the corresponding disc head (7, 7a, 7b, 7c).

4. Joint with three degrees of freedom according to claim 3, wherein the disc lining (10) is provided with a rotation stop (10b), the bearing support (9) of each disc (6, 6a, 6b, 6c) comprises a protrusion (9a) located on its bottom periphery, the outside diameter of the bottom periphery of the bearing support (9) being smaller than the inside diameter of the corresponding lining (10), so that a groove is then formed when the lining (10) and the bearing support (9) are assembled, interrupted by the protrusion (9a), the rotation stop (10b) of a disc and the protrusion (9a) of a disc immediately above cooperating in order to limit the rotation of the disc provided with the rotation stop (10b).

5. Joint with three degrees of freedom according to claim 4, wherein a disc lining (10) comprises two stops (10b), so as to be able to adjust, in cooperation with a protrusion (9a), a positive rotation angle of said disc independently of the negative rotation angle of said disc.

6. Joint with three degrees of freedom according to claim 4, wherein two protrusions are provided on a bearing support, so as to be able to adjust, in cooperation with a stop (10a), a positive rotation angle of said disc independently of the negative rotation angle of said disc.

7. Joint with three degrees of freedom according to claims 4 to 6, wherein a stop is repositionable by means of a removable fixing on the corresponding lining and/or a protrusion is repositionable by means of a removable fixing on the corresponding bearing support.

8. Joint with three degrees of freedom according to claim 1 to 3, wherein one or more teeth of the ring of a disc are omitted, so as to limit the rotation of the corresponding disc.

9. Joint with three degrees of freedom according to claim 1 to 8, wherein a motor (3a, 3b, 3c) is provided with means for determining the angular position of its output shaft with respect to a reference position.

10. Joint with three degrees of freedom according to claim 9, wherein the means for determining angular position comprise a plurality of magnetic sensors (13) distributed circularly around the cylindrical bar (T), associated with a magnetic element (15a, 15b, 15c) disposed in each disc head (7 a, 7 b, 7c)so as to be able to be detected by the magnetic sensors (13).

11. Joint with three degrees of freedom according to either one of claims 9 or 10, wherein the means for determining angular position comprise sensors (16a, 16b, 16c) in line with each rotation axis carrying a pinion (5a, 5b, 5c).

12. Joint with three degrees of freedom according to any one of claims 1 to 11, wherein the surface of the sphere(S) is provided with a coating minimising friction between the sphere(S) and the platform (2), in particular of the polytetrafluoroethylene type.

13. Joint with three degrees of freedom according to any one of claims 1 to 12, wherein the sphere(S), the cylindrical bar (T) and the base (B) are each provided with a through hole, each hole communicating with the others.

14. Robot limb, comprising at least two limb segments joined by a joint (1) with three degrees of freedom according to any one of claims 1 to 13.

15. Robot limb comprising at least two limb segments joined by a joint (1) with three degrees of freedom according to claim 13 as well as equipment disposed downstream of the joint (1) with three degrees of freedom, the cable supplying and/or controlling said equipment being disposed through the hole in the sphere(S) and the hollow cylindrical bar (T) and through the hole in the base (B), to emerge between the motors (3a, 3b, 3c).
